(19) United States
(12) Patent Application Publication
(10) Pub. No.: US 2023/0254385 A1
(43) Pub. Date: Aug. 10, 2023

(54) METHODS AND SYSTEMS FOR ENABLING REMOTE SHARING OF RESOURCES AMONG MEDICAL TEST AND MEASUREMENT INSTRUMENTS

(71) Applicant: Anilkumar Krishnakumar MISHRA, Fremont, CA (US)

(72) Inventor: Anilkumar Krishnakumar MISHRA, Fremont, CA (US)

(21) Appl. No.: 18/188,682

(22) Filed: Mar. 23, 2023

Related U.S. Application Data
(63) Continuation-in-part of application No. 15/842,719, filed on Dec. 14, 2017, now Pat. No. 11,182,417.
Application No. 15/842,719 is a continuation-in-part of application No. 16/129,574, filed on Sep. 12, 2018, now Pat. No. 11,363,084.
Application No. 16/129,574 is a continuation-in-part of application No. 17/509,629, filed on Oct. 25, 2021, now Pat. No. 11,636,131.

(51) Int. Cl. H04L 67/565; H04L 67/12

(52) U.S. Cl. CPC H04L 67/565; H04L 67/12

(57) ABSTRACT

Various embodiments provide method, device, and systems for sharing a remote processing server among one or more content sources. The one or more content sources may correspond to test and measurement signals. The method, performed by a sense and pickup device, includes measuring an input signal from the one or more content sources. In addition, the method includes receiving signal configuration information associated with the input signal from an input/output (I/O) unit or a remote processing server. Further, the method includes performing front-end signal conditioning and/or error reduction on the input signal in analog and/or digital domain with facilitation of analog and/or digital hardware to generate a front-end signal. Furthermore, the method includes transmitting at least the front-end signal to the remote processing server over a network. Moreover, the method includes receiving instructions from the remote processing server to display an output signal corresponding to the front-end signal.

### TECHNICAL FIELD

The present disclosure generally, but not exclusively, relates to signal processing and, more particularly, to a method and system for conversion of a signal from one form to another for enabling remote sharing of resources among test and measurement instruments used in electronic laboratories and medical facilities.

### BACKGROUND

Inside an electronic lab or a medical facility (e.g., hospital, medical laboratory, etc.), various tests and measurement instruments are used daily. Examples of the test and measurement instruments may include high-end multimeters, oscilloscopes, and so on. Each test and measurement instrument have a separate sense and pickup unit, an input/output (I/O) unit, a processing unit, and a power supply unit. Therefore, each test and measurement instrument consumes a lot of power during operation.

In a first example, various test and measurement instruments may be located together at the same site inside the medical facility. In a second example, the various test and measurement instruments may be located at different sites inside the medical facility. In a third example, the various tests and measurement instruments may be located remotely at various medical facilities. During operation, each test and measurement instrument utilizes a separate processing unit to process input signals. The processing unit generally needs more power than the other units for operation. In addition, each processing unit is connected to a power supply. In general, the power supply provides the required operating power to the processing unit.

### SUMMARY

Various embodiments of the present disclosure provide a method, device, and system for enabling remote sharing of a single processing server among one or more signal sources.

In an embodiment, a system is disclosed. The system includes one or more content sources. In addition, the system includes a sense and pickup device including a signal transceiver unit configured to receive signal configuration information associated with an input signal from an input/output (I/O) unit or a remote processing server. The I/O unit is communicatively coupled to the signal transceiver unit and the remote processing server. The input signal is selected from the one or more content sources based, at least in part, on a multiplexer. The sense and pickup device further include a signal conditioning unit configured to perform front-end signal conditioning and/or error reduction on the input signal in analog and/or digital domain with facilitation of analog and/or digital hardware to generate a front-end signal. Furthermore, the sense and pickup device includes the signal transceiver unit configured to transmit at least the front-end signal to the remote processing server over a network. The system also includes the remote processing server configured to perform processing on the front-end signal to generate an output signal. The processing is performed based, at least in part, on the signal configuration information and signal library files. Moreover, the system includes the I/O unit configured to receive instructions from the remote processing server to display the output signal in a desired format on a display.

In another embodiment, a method for sharing a remote processing server among one or more content sources is disclosed. The method includes receiving, by a sense and pickup device, an input signal from the one or more content sources. In addition, the method includes receiving, by the sense and pickup device, signal configuration information associated with the input signal from an input/output (I/O) unit or the remote processing server. Further, the method includes performing, by the sense and pickup device, front-end signal conditioning and/or error reduction on the input signal in analog and/or digital domain with facilitation of analog and/or digital hardware to generate a front-end signal. Furthermore, the method includes transmitting, by the sense and pickup device, at least the front-end signal to the remote processing server over a network. Moreover, the method includes receiving, by the sense and pickup device, instructions from the remote processing server to display an output signal corresponding to the front-end signal. The output signal is generated based at least on processing of the front-end signal by the remote processing server.

In yet another embodiment, a sense and pickup device is disclosed. The sense and pickup device include a signal transceiver unit, a signal conditioning unit, a memory including executable instructions, and a processor communicably coupled to the memory. The processor is configured to execute the instructions to cause the sense and pickup device, at least in part, to measure an input signal from one or more content sources. In addition, the sense and pickup device is caused to receive signal configuration information associated with the input signal from an input/output (I/O) unit or the remote processing server. Further, the sense and pickup device is caused to perform front-end signal conditioning and/or error reduction on the input signal in analog and/or digital domain with facilitation of analog and/or digital hardware to generate a front-end signal. Furthermore, the sense and pickup device is caused to transmit at least the front-end signal to the remote processing server over a network. Moreover, the sense and pickup device is caused to receive instructions from the remote processing server to display an output signal corresponding to the front-end signal. The output signal is generated based at least on processing of the front-end signal by the remote processing server.

Other aspects and example embodiments are provided in the drawings and the detailed description that follows.

### BRIEF DESCRIPTION OF THE FIGURES

For a more complete understanding of example embodiments of the present technology, reference is now made to the following descriptions taken in connection with the accompanying drawings in which:

FIG. 1A illustrates an environment related to an embodiment of the present invention;

FIG. 1B illustrates an environment related to another embodiment of the present invention;

FIG. 2A illustrates a block diagram representation of a sense and pickup device along with a content source, in accordance with an embodiment of the present invention;

FIG. 2B illustrates a block diagram representation of the sense and pickup device along with the content source, in accordance with another embodiment of the present invention;

FIG. 3 illustrates a block diagram representation of conversion of a physical test and measurement signal to an electrical test and measurement signal, in accordance with an embodiment of the present invention;

FIG. 4A illustrates an exemplary block diagram representation of selecting an input signal from one or more content sources, in accordance with an embodiment of the present invention;

FIG. 4B illustrates an exemplary block diagram representation for selecting the input signal from the one or more content sources, in accordance with another embodiment of the present invention;

FIG. 5A illustrates a block diagram representation of a system for enabling sharing of a remote processing server among the one or more content sources, in accordance with an embodiment of the present invention;

FIG. 5B illustrates a block diagram representation of a system for enabling sharing of the remote processing server among the one or more content sources, in accordance with another embodiment of the present invention;

FIG. 6 illustrates a block diagram representation of remotely sharing the remote processing server over one or more communication channels, in accordance with an embodiment of the present invention; and

FIG. 7 illustrates a flow diagram of a method for sharing the remote processing server among the one or more content sources, in accordance with an embodiment of the present invention.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

### OVERVIEW

Various embodiments disclosed herein provide methods, devices, and systems for enabling conversion of an input signal from one signal form to another signal form to enable remote sharing of a single processing server among one or more content sources (e.g., input signal sources). The one or more content sources may correspond to test and measurement signals generated by test and measurement instruments installed inside a facility (e.g., medical facility, medical laboratory, etc.). The one or more content sources then share the single processing server to save power and/or other resources, such as memory etc.

More specifically, the system includes the one or more content sources. In addition, the system includes a sense and pickup device including a signal transceiver unit configured to receive signal configuration information associated with an input signal from an input/output (I/O) unit. Further, the sense and pickup device includes a signal conditioning unit configured to perform front-end signal conditioning and/or error correction/reduction on the input signal in analog and/or digital domain to generate a front-end signal. It is noted that the I/O unit can be integrated with the sense and pickup device and/or remote. The signal transceiver unit is also configured to transmit at least the front-end signal to the remote processing server over a network.

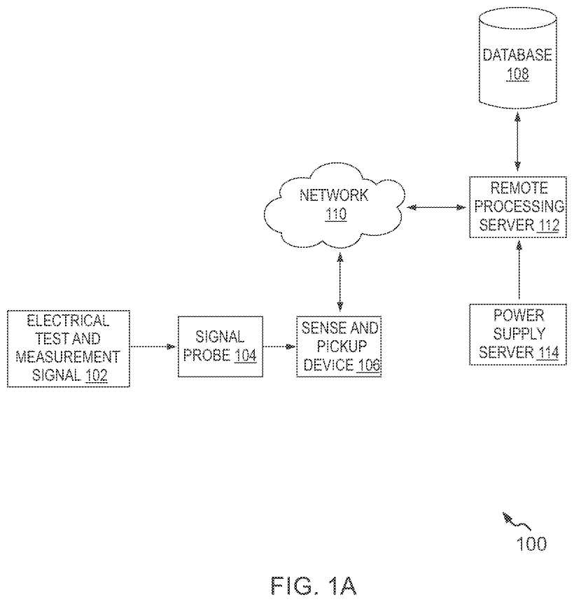

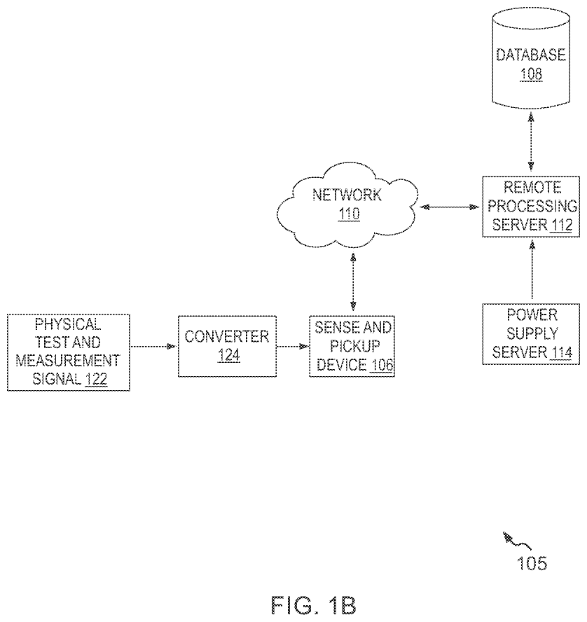

The remote processing server is then configured to perform processing on the front-end signal to generate an output signal in the desired format. Moreover, the system includes a shared power supply configured to provide operating power to the remote processing server. Various embodiments of the invention for sharing the remote processing server are explained in detail herein with reference to FIGS. 1A to 7.

FIG. 1A illustrates an environment 100 related to an embodiment of the present invention. It should be understood that the environment 100, illustrated and hereinafter described, is merely illustrative of an arrangement for describing some exemplary embodiments, and therefore, should not be taken to limit the scope of the embodiments. As such, it should be noted that at least some of the components described below in connection with the environment 100 may be optional and thus in some embodiments may include more, less, or different components than those described in connection with the embodiment of FIG. l A or with subsequent FIGS. 1B to 6.

The environment 100 depicts an electrical test and measurement signal 102, a signal probe 104, a sense and pickup device 106, a database 108, a remote processing server 112, and a power supply server 114, connected by a communication network, such as a network 110.

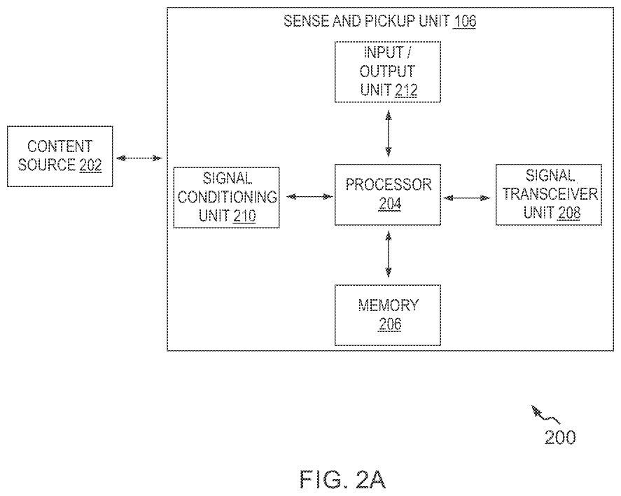

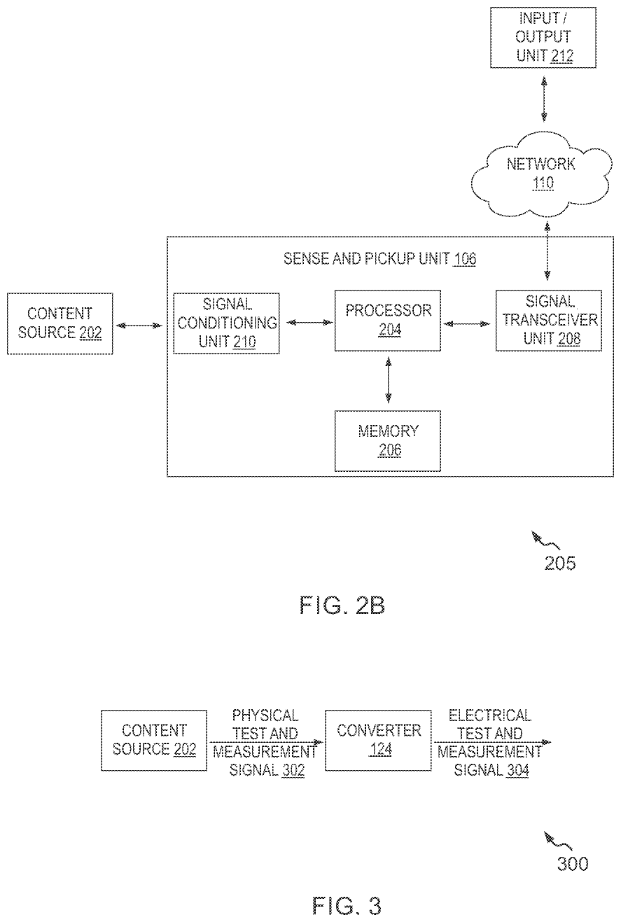

FIG. 1B illustrates an environment 105 related to another embodiment of the present invention. It should be understood that the environment 105, illustrated and hereinafter described, is merely illustrative of an arrangement for describing some exemplary embodiments, and therefore, should not be taken to limit the scope of the embodiments. As such, it should be noted that at least some of the components described below in connection with the environment 105 may be optional and thus in some embodiments may include more, less, or different components than those described in connection with the embodiment of FIG. 1B or with subsequent FIGS. 2 to 6.

The environment 105 depicts a physical test and measurement signal 122, a converter 124, the sense and pickup device 106, the database 108, the remote processing server 112, and the power supply server 114, connected by a communication network, such as the network 110.

The electrical test and measurement signal 102 or the physical test and measurement signal 122 may be measured by a test and measurement instrument. Examples of the test and measurement instrument include high-end multimeters, oscilloscopes, and the like. In one embodiment, the electrical test and measurement signal 102 hereinafter may be referred to as content source. In one embodiment, the physical test and measurement signal 122 hereinafter may be referred to as the content source.

The test and measurement instrument (not shown in figures) may correspond to any medical instrument capable of measuring a signal (may interchangeably also be referred to as test and measurement signal) (i.e., the electrical test and measurement signal 102 or the physical test and measurement signal 122). In an embodiment, the test and measurement instrument (not shown in figures) measure the signal. In another embodiment, the test and measurement instrument generate the signal.

In an example, the electrical test and measurement signal 102 can be a voltage at a node in an electrical/electronic circuit. In another example, the electrical test and measurement signal 102 can be an electrical/electronic current. Further, the electrical test and measurement signal 102 can either be an analog signal or a digital signal. Examples of analog signals may include analog voltages and currents. Examples of digital signals may include sensing whether a switch is closed or not.

Examples of the physical test and measurement signal 122 include audio signal, light signal, weight signal, and the like. In an embodiment, the test and measurement instruments are situated at a single site inside a medical facility (e.g., hospital, medical laboratory, and the like). In another embodiment, the test and measurement instruments are situated at multiple sites inside the medical facility. In yet another embodiment, the test and measurement instruments are situated at various medical facilities.

It is noted that the physical test and measurement signal 122 needs conversion before performing other operations on the signal. Therefore, in case of the physical test and measurement signal 122, the converter 124 is configured to convert the signal from a first signal form to a second signal form. The first signal form herein corresponds to a physical signal form, and the second signal form herein corresponds to an electrical signal form.

In one embodiment, the converter 124 corresponds to a transducer. In one embodiment, the converter 124 exists within the sense and pickup device 106. In one preferred embodiment, the physical test and measurement signal 122 is passed through the converter 124. The converter 124 is then configured to convert the signal from the physical test and measurement signal 122 to an electrical test and measurement signal (e.g., the electrical test and measurement signal 102).

In case of the electrical test and measurement signal 102, the signal probe 104 is configured to measure the signal at the sense and pickup device 106. In one example, the signal probe 104 facilitates transmission of the signal to the sense and pickup device 106 without any modification in the quality of the signal.

Further, the sense and pickup device 106 is configured to receive signal configuration information associated with an input signal from an input/output (I/O) unit. The input signal corresponds to an electrical test and measurement signal (e.g., the electrical test and measurement signal 102). In one embodiment, the input signal is one of analog or digital. In one embodiment, the I/O unit 212 is communicably coupled to the sense and pickup device 106 and the remote processing server. In an embodiment, the sense and pickup device 106 receives the signal configuration information from the I/O unit 212 over a network. In one embodiment, the network 110 corresponds to one of a wired network connection or a wireless network connection.

In one example, the I/O unit 212 transmits the signal configuration information to the sense and pickup device 106. In parallel, the I/O unit 212 transmits the signal configuration information to the remote processing server. In one example, the signal configuration information may include input signal range selection. In one example, the I/O unit 212 may correspond to a handheld touch pad having a display for displaying an output and a touchpad for receiving an input. The I/O unit 212 may receive input and display output based on an application running in background. In one embodiment, the signal configuration information may be received from a user with facilitation of the I/O unit 212. In some examples, the I/O unit 212 may include a keyboard for receiving input and multielement alphanumeric light-emitting diode (LED) and liquid crystal display (LCD) displays for displaying the output.

In addition, the sense and pickup device 106 performs front-end signal conditioning and/or error reduction on the input signal based, at least in part, on the signal configuration information to generate a front-end signal corresponding to the input signal. The sense and pickup device 106 further transmit the front-end signal to the remote processing server 112 for further processing. The remote processing server 112 may then perform the desired processing on the front-end signal to generate the output signal. It is noted that the output signal may include more than one number of output signals.

In FIG. 1A, only one electrical test and measurement signal 102 is shown; however, there can be any number of electrical test and measurement signals measured from any number of test and measurement instruments. In FIG. 1B, only one physical test and measurement signal 122 is shown; however, there can be any number of physical test and measurement signals measured from any number of test and measurement instruments. In real-time, the remote processing server 112 is shared among the one or more content sources (i.e., various signal sources) since the remote processing server 112 receives the signals from the one or more content sources.

For example, the remote processing server 112 is configured to receive both the electrical test and measurement signal 102 and the physical test and measurement signal 122. In addition, the electrical test and measurement signal 102 can include any number of electrical test and measurement signals and the physical test and measurement signal 122 can include any number of physical test and measurement signals. Instead of processing the various test and measurement signals at separate processing servers, the remote processing server 112 performs the processing of the various test and measurement signals in one place.

In an embodiment, the sense and pickup device 106 may display the output signal on a display unit (e.g., the I/O unit 212). In another embodiment, the sense and pickup device 106 may further transmit the output signal to a remote I/O unit 212. The remote processing server 112 draws power for operation from the power supply server 114. In an example, the power supply server 114 may draw alternating current (AC) power from a mains power supply and convert it into direct current (DC). The power supply server 114 may then provide DC to the remote processing server 112.

The sense and pickup device 106 may communicate with the remote processing server 112 via the network 110. In an embodiment, the I/O unit 212 may communicate with the sense and pickup device 106 or the remote processing server 112 via the network 110. The network 110 may be a centralized network or may include a plurality of sub-networks that may offer direct or indirect communication using any existing transmission media between the I/O unit 212 and the remote processing server 112. For example, the network 110 may include wired networks, wireless networks, and combinations thereof. Various non-limiting examples of wired networks may include Ethernet, local area networks (LANs), fiber-optic networks, and the like. Some non-limiting examples of wireless networks may include cellular networks like GSM/3G/4G/5G/LTE/CDMA networks, wireless LANs, Bluetooth, Wi-Fi, or ZigBee networks, and the like. An example of the combination of wired and wireless networks may include the Internet.

In one preferred example, a user (not shown in figures) may input the signal configuration information in the I/O unit 212 communicably coupled to the sense and pickup device 106 and the remote processing server 112. In one example, the user may install the sense and pickup device 106 between the test and measurement signal sources and the remote processing server 112. The sense and pickup device 106 may then facilitate the communication with the remote processing server 112 via the network 110.

In one embodiment, the database 108 is associated with the remote processing server. The database 108 can store the processed signal (i.e., the output signal) for later use. The database 108 may also store signal library files required for performing front-end signal conditioning and/or error reduction on the signal. In an embodiment, the database 108 is a cloud database. In one example, the database 108 may also provide a storage location to the metadata generated during the front-end signal conditioning and/or error reduction operations. In general, database is an organized collection of structured information, or data, typically stored electronically in a computer system.

The database 108 is any computer-operated hardware suitable for storing and/or retrieving data, such as but not limited to, signal library files, signal characteristics, signal configuration information, and metadata associated with input and/or output signals. The database 108 may include multiple storage units such as hard disks and/or solid-state disks in a redundant array of inexpensive disks (RAID) configuration. The database 108 may include a storage area network (SAN) and/or a network-attached storage (NAS) system.

In some alternate embodiments, the database 108 may also include magnetic storage devices (such as hard disk drives, floppy disks, magnetic tapes, etc.), optical magnetic storage devices (e.g., magneto-optical disks), semiconductor memories (such as mask ROM, programmable ROM (PROM), erasable PROM (EPROM), Phase-change memory, flash ROM, random access memory (RAM)), etc.

The number and arrangement of systems, devices, and/or networks shown in FIG. 1A and 1B are provided as an example. There may be additional systems, devices, and/or networks; fewer systems, devices, and/or networks; different systems, devices, and/or networks, and/or differently arranged systems, devices, and/or networks than those shown in FIG. 1A and 1B. Furthermore, two or more systems or devices shown in FIG. 1A and 1B may be implemented within a single system or device, or a single system or device shown in FIG. 1A and 1B may be implemented as multiple, distributed systems or devices. Additionally, or alternatively, a set of systems (e.g., one or more systems) or a set of devices (e.g., one or more devices) of the environment 100 and the environment 105 may perform one or more functions described as being performed by another set of systems or another set of devices of the environment 100 and the environment 105.

FIG. 2A illustrates a block diagram representation 200 of the sense and pickup device 106 along with a content source, in accordance with an embodiment of the present invention. FIG. 2B illustrates a block diagram representation 205 of the sense and pickup device 106 along with the content source, in accordance with another embodiment of the present invention.

The sense and pickup device 106 is shown in communication with a content source 202. It is noted that there can be one or more content sources. The content source 202 corresponds to a test and measurement signal (e.g., the electrical test and measurement signal 102 or the physical test and measurement signal 122).

With reference to FIG. 2A, the sense and pickup device 106 include at least one processor 204, a memory 206, a signal transceiver unit 208, a signal conditioning unit 210, and an input/output (I/O) unit 212. The processor 204 is operatively coupled with the memory 206, the signal transceiver unit 208, the signal conditioning unit 210, and the I/O unit 212.

With reference to FIG. 2B, the sense and pickup device 106 include the processor 204, the memory 206, the signal transceiver unit 208, and the signal conditioning unit 210. The I/O unit 212 is located remotely. In addition, the I/O unit 212 communicates with the sense and pickup device 106 over the network 110. The processor 204 is operatively coupled with the memory 206, the signal transceiver unit 208, and the signal conditioning unit 210.

The processor 204 is capable of executing stored machine-executable instructions stored in the memory 206 of the sense and pickup device 106. The processor 204 is configured to perform various operations. For example, the processor 204 is configured to enable the signal conditioning unit 210 to perform the front-end signal conditioning and/or error reduction on an input signal. In another example, the processor 204 is configured to enable the I/O unit 212 to receive signal configuration information associated with the input signal from a user. In yet another example, the processor 204 is configured to enable the signal transceiver unit 208 to transmit the signal configuration information to the remote processing server 112.

The processor 204 is capable of executing one or more complex digital signal processing (DSP) algorithms such as, but not limited to, Convolution, Fast Fourier Transform (FFT), Correlation, Adaptive filtering, Kalman filtering, Wavelet Transform, and Compression algorithm. The processor 204, in conjunction with the signal conditioning unit 210, is configured to facilitate front-end signal conditioning and quality enhancement of the input signal (i.e., selected from the one or more content sources) based at least on utilization of the signal library files.

In an embodiment, the processor 204 may be embodied as one or more of various processing devices, such as a co-processor, a microprocessor, a controller, a digital signal processor (DSP), processing circuitry with an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

The memory 206 may be configured to store signal conditioning instructions (e.g., signal conditioning and/or error reduction instructions) for the processor 204 to execute for performing front-end signal conditioning and/or error reduction on the input signal. The memory 206 is a storage device embodied as one or more volatile memory devices, one or more non-volatile memory devices, and/or a combination of one or more volatile memory devices and non-volatile memory devices, for storing micro-content information and instructions. The memory 206 may be embodied as magnetic storage devices (such as hard disk drives, floppy disks, magnetic tapes, etc.), optical magnetic storage devices (e.g., magneto-optical disks), compact disc read-only memory (CD-ROM), compact disc recordable (CD-R), compact disc rewritable (CD-R/W), Digital Versatile Disc (DVD), BLU-RAY® Disc (BD), and semiconductor memories (such as mask ROM, programmable ROM (PROM), erasable PROM (EPROM), flash ROM, random access memory (RAM), etc.).

In an embodiment, the signal transceiver unit 208 is configured to transmit the front-end signal to the remote processing server over the network. More specifically, a transmitter of the signal transceiver unit 208 is configured to transmit the front-end signal to the remote processing server over the network. In an embodiment, the signal transceiver unit 208 is configured to receive signal configuration information associated with the electrical test and measurement signal 102 from the I/O unit 212 or the remote processing server. More specifically, a receiver of the signal transceiver unit 208 is configured to receive the signal configuration information associated with the electrical test and measurement signal 102 from the input/output (I/O) unit or the remote processing server. The signal configuration information may include information such as, but not limited to range of signal, accuracy desired, and precision desired.

In an embodiment, the I/O unit 212 is configured to transmit the signal configuration information associated with the input signal to the sense and pick up device 106 and the remote processing server 112. In addition, the I/O unit 212 is configured to display the output signal received from the remote processing server 112 in desired format.

To that effect, the I/O unit 212 may include at least one input interface and/or at least one output interface. Examples of the input interface may include, but are not limited to, a keyboard, a mouse, a joystick, a keypad, a touch screen, soft keys, a microphone, and the like. Examples of the output interface may include, but are not limited to, a user interface (UI) display (such as a light-emitting diode (LED) display, a thin-film transistor (TFT) display, a liquid crystal display (LCD), an active-matrix organic light-emitting diode (AMOLED) display, etc.), a speaker, a ringer, a vibrator, and the like.

The signal conditioning unit 210 is configured to perform front-end signal conditioning and/or error reduction on the input signal in analog and/or digital domain with facilitation of analog and/or digital hardware to generate a front-end signal. The front-end signal is generated corresponding to the input signal. The front-end signal conditioning and/or error reduction is performed prior to transmission of the front-end signal to the remote processing server 112. The front-end signal conditioning and/or error reduction is performed based at least on the signal configuration information received from the I/O unit 212 and/or from the remote processing server.

In one example, the signal conditioning unit 210 is configured to filter out undesired harmonic/frequency content from the input signal at the sense and pickup device 106 by utilizing the AI unit. The harmonic/frequency content to be filtered out can be statistically known between the sense and pickup device 106 and the remote processing server 112 ahead of time. The remote processing server 112 may choose to add the filtered harmonic content back to the output signal with desired energy.

In an embodiment, the signal transceiver unit 208 is configured to receive instructions from the I/O unit 212 or the remote processing server 112 for configuring the signal conditioning unit 210. The I/O unit 212, based upon the instructions, then instructs the signal conditioning unit 210 to perform the front-end signal conditioning and/or error reduction on the input signal to generate the front-end signal.

In one embodiment, the signal transceiver unit 208 is configured to transmit the front-end signal from the sense and pick up device 106 to the remote processing server 112 for processing. In addition, the signal transceiver unit 208 is configured to receive the signal configuration information from the I/O unit 212 and/or the remote processing server 112. In some examples, the signal configuration information includes range selection of signal, desired accuracy, desired resolution, and the like. In one embodiment, the I/O unit 212 is configured to receive the processed data (i.e., the output signal) from the remote processing server 112 for display on a display.

In an embodiment, the signal transceiver unit 208 is configured to transmit metadata and/or data associated with the sense and pick up device 106 to the remote processing server 112 over the network 110. In an embodiment, the signal transceiver unit 208 is configured to receive the signal configuration information from the I/O unit 212 and the remote processing server 112 over the network 110. The network 110 corresponds to one of a wired network connection or a wireless network connection. In another embodiment, the I/O unit 212 is configured to receive instructions from the remote processing server 112 to display the output signal in desired format on a display. The I/O unit 212 is configured to receive such instructions over the network 110.

In an embodiment, the signal transceiver unit 208 is configured to transmit the front-end signal to the remote processing server 112 via at least one communication channel. In addition, the I/O unit 212 is configured to transmit the signal configuration information associated with the input signal to the sense and pick-up device 106. In one embodiment, the I/O unit 212 is configured to transmit the signal configuration information associated with the input signal to the remote processing server 112 via at least one communication channel.

In an embodiment, the signal transceiver unit 208 includes a transmitter and a receiver. The receiver of the signal transceiver unit 208 is configured to receive the processed data (i.e., the output signal) from the remote processing server 112. The processed data can then be displayed on an output unit of the I/O unit 212. In addition, the receiver of the signal transceiver unit 208 is configured to receive the signal configuration information from a remote I/O unit (e.g., the I/O unit 212) and/or the remote processing server 112 over the network 110. In one embodiment, the receiver of the signal transceiver unit 208 is configured to receive the signal library files over the network 110. In a nutshell, the signal transceiver unit 208 is configured to transmit and receive data/information with the remote I/O unit 212 and the remote processing server 112 over the network 110.

The remote processing server 112 may then perform the processing on the front-end signal. In one embodiment, the remote processing server 112 may also utilize the signal library files to perform the processing on the front-end signal. In one embodiment, the remote processing server 112 can communicate with the database 108. In an embodiment, the remote processing server 112 generates the output signal from the front-end signal based on signal characteristics. The signal characteristics may be accessed from the signal library files for conversion of the front-end signal to the output signal. In one embodiment, the remote processing server 112 is configured to store the processed signal (i.e., the output signal) in the database 108. In one embodiment, the remote processing server 112 is configured to process the front-end signal in analog and/or digital form.

In an embodiment, the signal characteristics are stored as digitized data organized as objects of a class into each signal library file. In an embodiment, the signal library files are generated by an artificial intelligence (AI) unit (not shown in figures). In an embodiment, the generation of the output signal from the front-end signal includes filtering out some of the signal characteristics of the front-end signal based on the signal library files and hardware-run AI-based algorithms.

In an embodiment, the signal transceiver unit 208 is configured to receive the output signal corresponding to the front-end signal based at least on processing of the front-end signal by the remote processing server 112. Further, the remote processing server 112 provides instructions to the I/O unit 212 to display the output signal in a desired format on a display. In an embodiment, the display is embedded within the sense and pickup device 106. The I/O unit 212 is configured to display the output signal corresponding to the front-end signal based at least on processing of the front-end signal by the remote processing server 112.

In one embodiment, the I/O unit 212 (if and when integrated with the sense and pick up device 106) (e.g., display unit (not shown in figures)) is configured to display the output signal received from the remote processing server 112 on a display of the sense and pickup device 106. Examples of the display may include cathode ray tube (CRT) monitors, liquid crystal displays (LCDs), touchscreens, projector displays, flat panel displays, plasma displays, and the like.

In one embodiment, the signal transceiver unit 208 is configured to transmit at least one configuration data (e.g., range, accuracy, etc.) to the signal conditioning unit 210 of the sense and pick up device 106 through the processor 204. In one embodiment, the signal transceiver unit 208 is configured to transmit the front-end signal either over legally allowed radio frequencies or as a stream over the internet/intranet. In various examples, the signal transceiver unit 208 can be wired or wireless intranet and/or internet. Another example of the signal transceiver unit 208 can be a radio frequency modulator and amplifier that can transmit signals over legally allowed radio frequencies.

The signal transceiver unit 208 can also take the example of any other sense and pickup device 106 that can be used to send signal by any suitable communication medium so that the signal can be received by a receiver. In practical examples, the signal transceiver unit 208 can also transmit different converted signals as different streams on the internet/intranet and the receiver can receive these streams selectively through the internet/intranet.

With reference to FIG. 2B, the I/O unit 212 is in communication with the sense and pickup device 106 via the network 110. In an embodiment, the network 110 represents a wired network connection. In another embodiment, the network 110 represents a wireless network connection.

In an embodiment, the I/O unit 212 is configured to handle remote I/O units of multiple sense and pickup devices of the same or different types based on an operating system or application running in the sense and pickup device. In one embodiment, the sense and pickup device 106 may run an application within an operating system (OS).

It is understood that all the units (e.g., the signal conditioning unit 210, the signal transceiver unit 208, etc.) of the sense and pickup device 106 can be built into the sense and pickup device 106 itself or can be coupled to the sense and pickup device 106 via wired or wireless connections (e.g., the network 110). This allows the sense and pickup device 106 and the I/O unit 212 and the remote processing server 112 to be remotely located.

In an embodiment, the remote processing server 112 has inbuilt artificial intelligence (AI) capabilities that enable the remote processing server 112 to learn and upgrade its processing based on various front-end signals received from various test and measurement instruments and/or provide insights and/or analysis of the processed signals.

FIG. 3 illustrates a block diagram representation 300 of conversion of the physical test and measurement signal 122 to the electrical test and measurement signal 102, in accordance with an embodiment of the present invention.

The block diagram representation 300 includes the content source 202, a physical test and measurement signal 302, the converter 124, and an electrical test and measurement signal 304. In one embodiment, the physical test and measurement signal 302 is measured from a test and measurement instrument. The physical test and measurement signal 302 is identical to the physical test and measurement signal 122.

In an embodiment, the converter 124 is a transducer. In general, transducer is a device that converts variations in a physical quantity (e.g., brightness, pressure, etc.) into an electrical signal. More specifically, the transducer is a device that converts energy from physical form to energy in electrical form. In an embodiment, the transducer converts the physical test and measurement signal 302 to the electrical test and measurement signal 304. The electrical test and measurement signal 304 is identical to the electrical test and measurement signal 102.

In an example, the transducer may correspond to a thermocouple configured to convert temperature in electrical signal form. In another example, the transducer may correspond to a microphone configured to convert audio signal to electrical signal form. In yet another example, the transducer may correspond to a strain gauge that converts weight in electrical signal form. In yet another example, the transducer may correspond to a photo diode that converts light in electrical signal form.

In an embodiment, the content source 202 corresponds to the physical test and measurement signal 302. In addition, the physical test and measurement signal 302 may be generated by a test and measurement instrument installed inside a medical facility (e.g., hospital, medical laboratory, etc.).

The physical test and measurement signal 302 is then passed through the converter 124. In one embodiment, the converter 124 may be connected in between the content source 202 and the sense and pickup device 106. In other words, the physical test and measurement signal 302, upon passing through the converter 124, is converted into the electrical test and measurement signal 304.

In one example, the electrical test and measurement signal 304 can be represented as a voltage at a node in an electrical/electronic circuit. In addition, the electrical test and measurement signal 304 is at least one of an analog signal or a digital signal. Examples of the analog signal may include, but are not limited to, analog voltages, and currents. Examples of the digital signal may include sensing whether a switch is closed or not (i.e., in the form of 0 or 1).

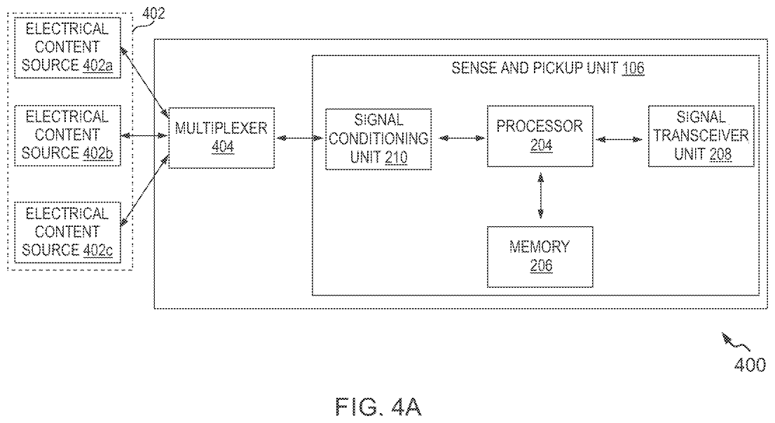

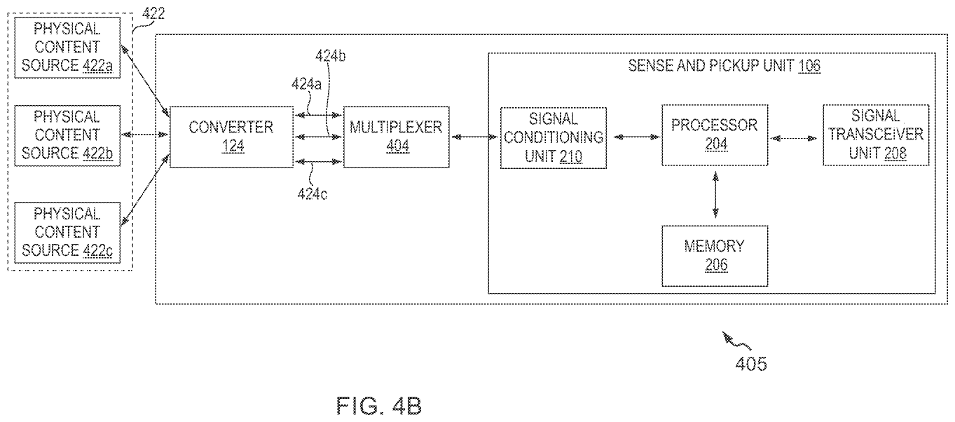

FIG. 4A illustrates an exemplary block diagram representation 400 of selecting an input signal from one or more content sources, in accordance with an embodiment of the present invention. The block diagram representation 400 includes an electrical content source 402a, an electrical content source 402b, and an electrical content source 402c (collectively referred to as electrical content sources 402) (i.e., the one or more content sources). It is noted that the electrical content sources 402 may include ‘n’ number of electrical content sources, where ‘n’ is a natural number.

The electrical content sources 402 correspond to electrical test and measurement signals (e.g., the electrical test and measurement signal 102). The electrical test and measurement signals may be measured from one or more test and measurement instruments. The electrical content sources 402 are then passed through a multiplexer 404. The multiplexer 404 selects between several analog or digital input signals (i.e., the electrical content sources 402) and forwards the selected input (i.e., the input signal) to the signal conditioning unit 210. In one example, the multiplexer 404 may perform the selection based at least on the signal configuration information received from the I/O unit 212. In an embodiment, the multiplexer 404 is an internal component of the sense and pickup device. In other words, the input signal is selected from one or more content sources (i.e., the electrical content sources 402) based, at least in part, on the multiplexer 404.

The signal conditioning unit 210 may then perform the front-end signal conditioning and/or error reduction on the input signal to generate the front-end signal. The detailed explanation of working of the signal conditioning unit 210, the signal transceiver unit 208, the processor 204, and the memory 206 is explained in detail with reference to FIG. 2, and therefore, it is not reiterated for the sake of brevity.

FIG. 4B illustrates an exemplary block diagram representation 405 selecting the input signal from the one or more content sources, in accordance with another embodiment of the present invention. The block diagram representation 405 includes a physical content source 422a, a physical content source 422b, and a physical content source 422c (collectively referred to as physical content sources 422) (i.e., the one or more content sources). It is noted that the physical content sources may include ‘m’ number of physical content sources, where ‘m’ is a natural number.

The physical content sources 422 correspond to physical test and measurement signals (e.g., the physical test and measurement signal 122). The physical test and measurement signals may be measured from the one or more test and measurement instruments. The physical content sources 422 are then passed through the converter 124.

The converter 124 is configured to convert the physical content sources 422 to electrical content sources (i.e., the electrical content sources 402). In one embodiment, the converter 124 corresponds to a transducer. For example, the converter 124 is configured to convert the physical content source 422a into an electrical content source 424a. Similarly, the converter 124 is configured to convert the physical content source 422b into an electrical content source 424b, the physical content source 422c into an electrical content source 424c, and so on. In case of the electrical content sources 422, no conversion needs to be performed.

The electrical content sources (i.e., the electrical content source 424a, the electrical content source 424b, and the electrical content source 424c) are then passed through the multiplexer 404. The multiplexer 404 selects between the several analog or digital input signals (i.e., the electrical content source 424a, the electrical content source 424b, and the electrical content source 424c) and forwards the selected input (i.e., the input signal) to the signal conditioning unit 210.

In one example, the multiplexer 404 may perform the selection based at least on the signal configuration information received from the I/O unit 212. In an embodiment, the multiplexer 404 is an internal component of the sense and pickup device 106. In an embodiment, the converter 124 is an internal component of the sense and pickup device 106.

The signal conditioning unit 210 may then perform the front-end signal conditioning and/or error reduction on the input signal to generate the front-end signal. The detailed explanation of working of the signal conditioning unit 210, the signal transceiver unit 208, the processor 204, and the memory 206 is explained in detail with reference to FIG. 2, and therefore, it is not reiterated for the sake of brevity.

In one embodiment, the sense and pick unit can have the multiplexer 404 embedded before the signal conditioning unit 210 (as shown in FIG. 4A and 4B). The multiplexer 404 is configured to select/multiplex one of multiple signal sources to the signal conditioning unit 210. The selection can be performed based at least on the signal configuration information received from the I/O unit 212 and/or the remote processing server.

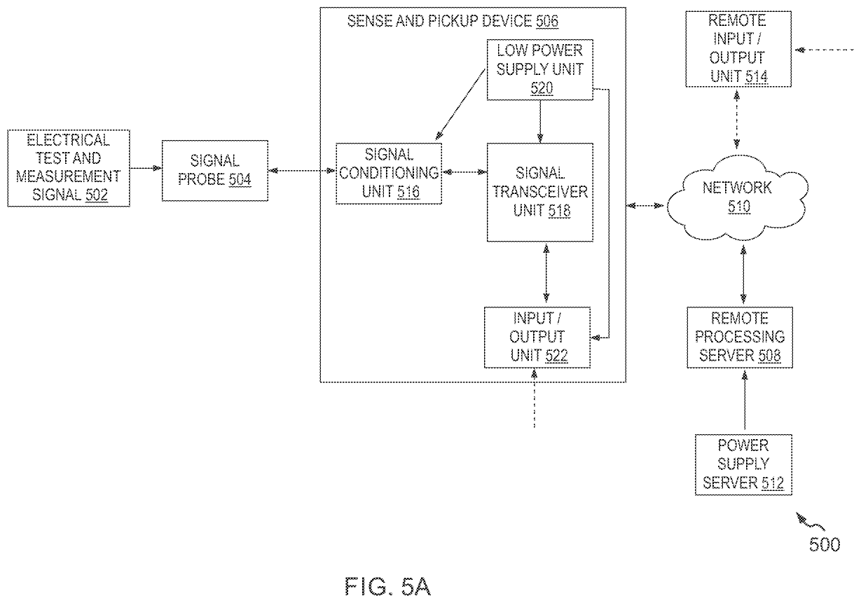

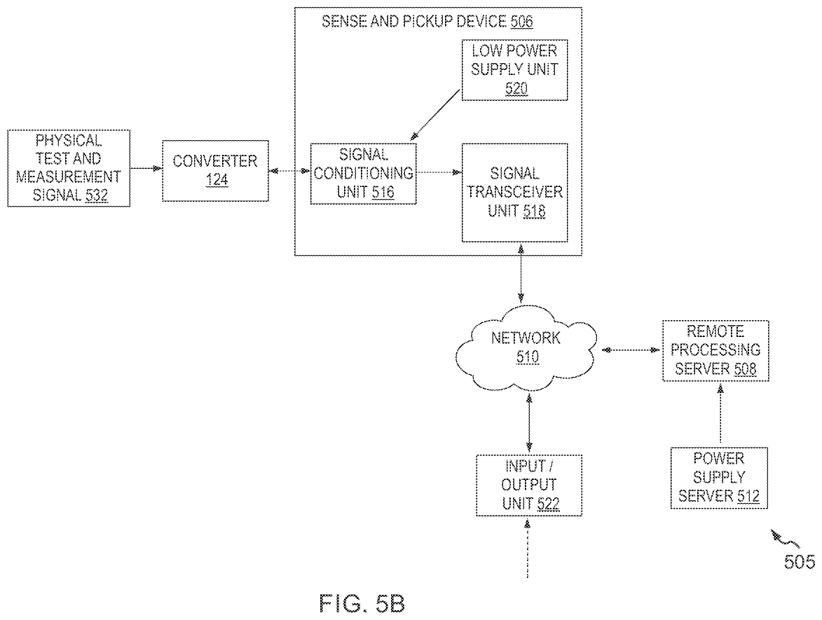

FIG. 5A illustrates a block diagram representation of a system 500 for enabling sharing of the remote processing server 112 among the one or more content sources, in accordance with an embodiment of the present invention.

With reference to FIG. 5A, the system 500 includes an electrical test and measurement signal 502 (e.g., the electrical test and measurement signal 102), a signal probe 504, a sense and pickup device 506, a remote I/O unit 514, a remote processing server 508, a network 510 (e.g., the network 110), and a power supply server 512. In addition, the sense and pickup device 506 includes a signal conditioning unit 516, a signal transceiver unit 518, a low power supply unit 520, and an input/output (I/O) unit 522. The I/O unit 522 is integrated with the sense and pick up device 106. The I/O unit 514 is remotely connected via the network (e.g., the network 110) to the sense and pick up device 106 and the remote processing server 112.

The signal probe 504 is identical to the signal probe 104. The sense and pickup device 506 is identical to the sense and pickup device 106. The remote processing server 508 is identical to the remote processing server 112. The power supply server 512 is identical to the power supply server 114.

In addition, the signal conditioning unit 516 is identical to the signal conditioning unit 210. The signal transceiver unit 518 is identical to the signal transceiver unit 208. The I/O unit 522 is identical to the I/O unit 212. In addition, the remote I/O unit 514 is identical to the I/O unit 212.

FIG. 5B illustrates a block diagram representation of a system 505 for enabling sharing of the remote processing server 112 among the one or more content sources, in accordance with another embodiment of the present invention.

With reference to FIG. 5B, the system 505 includes the physical test and measurement signal 532 (e.g., the physical test and measurement signal 122), the converter 124, the sense and pickup device 506, the input/output (I/O) unit 514, the remote processing server 508, the network 510 (e.g., the network 110), and the power supply server 512. In addition, the sense and pickup device 506 includes the signal conditioning unit 516, the signal transceiver unit 518, and the low power supply unit 520. In FIG. 5B, the I/O unit 514 exists remotely from the sense and pickup device 506.

The one or more content sources include at least one of the physical test and measurement signals (hereinafter referred to as physical signal 532) and the electrical test and measurement signals (hereinafter referred to as electrical signal 502). In case of the physical signal 532, the conversion from the physical signal 532 to the electrical signal 502 needs to be performed. The converter 124 is configured to convert the physical signal 532 to the electrical signal 502. In addition, the input signal is selected from the one or more content sources based, at least in part, on the multiplexer 404. The detailed explanation of selecting the input signal from the one or more content sources is explained in FIGS. 4A and 4B; and therefore, it is not reiterated for the sake of brevity.

In one embodiment, the content source 202 may correspond to the test and measurement signal source (e.g., the test and measurement instrument). In one example, the test and measurement signal source 102 may be situated inside a medical facility. In an embodiment, the content source 202 may represent a single content source. In another embodiment, the content source 202 may represent ‘p’ number of content sources, where ‘p’ is a natural number.

In one embodiment, the content source 202 of the one or more content sources is configured to measure the input signal (i.e., content signal). In one embodiment, the input signal is one of analog or digital. In other words, the input signal is an electrical signal and not a physical signal. In case of the physical signal, the physical signal is converted into the electrical signal by the converter 124. In one embodiment, the content source 202 is configured to generate the input signal.

The conversion of the signal form is performed so that the remote processing server 508 measures the input signal in electrical signal form only. In case the input signal is already in electrical signal form, then no conversion needs to be done. In this case, there is no need to use the converter 124.

In one embodiment, a user (not shown in figures) may use the signal probe 504 to provide the input signal to the sense and pickup device. Since the input signal is an electrical signal, the signal probe 504 measures the input signal at the sense and pickup device 106 without any modification in the input signal.

In an embodiment, the signal transceiver unit 518 is configured to receive the signal configuration information associated with the input signal from the I/O unit 522 and/or the remote processing server. In addition, the signal transceiver unit 518 is configured to transmit raw data from the sense and pick up device 106 to the remote processing unit. The I/O unit 522 is communicatively coupled to the signal transceiver unit 518 and the remote processing server. The input signal is selected from the one or more content sources based, at least in part, on the multiplexer 404. In some examples, a remote I/O unit (e.g., the I/O unit 522) can also integrate function of shared processing unit.

Further, the signal conditioning unit 516 is configured to perform front-end signal conditioning and/or error reduction on the input signal in analog and/or digital domain with facilitation of analog and/or digital hardware to generate the front-end signal. The front-end signal conditioning and/or error reduction is performed prior to transmission of the front-end signal to the remote processing server 508. In addition, the signal conditioning unit 516 is configured to perform the front-end signal conditioning and/or error reduction based, at least in part, on the utilization of the signal library files.

In an embodiment, the signal library files may correspond to files including data related to the enhancement of signal quality. In another embodiment, the signal library files may correspond to files including data related to the reduction of errors from the signals. In yet another embodiment, the signal library files may correspond to files including data related to signal handling. In yet another embodiment, the signal library files may correspond to files including data related to signal transmission. In yet another embodiment, the signal library files may correspond to files including data related to signal conversion. The transceiver unit of the sense and pickup device facilitates the communication with the signal library files. In one embodiment, the signal transceiver unit 518 is configured to receive the signal library files over the network 510.

Therefore, the signal library files may include, but are not limited to, signal quality enhancement files, signal error reduction files, signal handling files, signal transmission files, and signal conversion files. In an embodiment, the AI unit is configured to generate the signal library files. In another embodiment, the signal library files are stored in a database (e.g., the database 108 of FIG. 1) communicably coupled to the remote processing server. In one example, the database 108 is a cloud database.

The AI unit is communicably coupled to the remote processing server. In an embodiment, the database 108 has pre-stored signal library files with various degrees of precision and accuracy. In an example, in case of damage, the AI unit can be replaced with another AI unit. In one embodiment, the AI unit may correspond to a silicon-based AI chip that can be attached to or detached from the remote processing server with ease.

In an embodiment, the AI unit is an artificial intelligence-based chip made up of digital and analog hardware, processing signals in digital and analog domains. The AI unit can be interfaced/connected with all input-output devices over wired or wireless networks such as the network 110 of FIG. 1. In one embodiment, the AI unit, can also exist inside the sense and pickup device 106 as per requirement and depending upon cost, precision, accuracy desired, and any other human deciding factors.

The signal quality enhancement files may include signal quality enhancement characteristics that can facilitate the signal conditioning unit 516 to enhance the quality of the input signal. The signal error reduction files may include signal error reduction characteristics that can facilitate the signal conditioning unit 516 to reduce errors in the input signal. The signal handling files may include signal handling characteristics that can facilitate the signal conditioning unit 516 to easily handle the input signal. The signal transmission files may include signal transmission characteristics that can facilitate the signal conditioning unit 516 to transmit the input signal. The signal conversion files may include signal conversion characteristics that can facilitate the signal conditioning unit 516 to convert the input signal.

In an embodiment, the signal library files can be updated on a periodic basis. In an embodiment, the signal library files can be sophisticated as per daily usage of the remote processing server 112 by updating new input signals on a periodic basis for later use. In one embodiment, the signal library files can also be edited. The signal library files can be put in a learning mode algorithm, which can learn and enhance the signal library files by learning from pre-stored signals or real-time signals being measured from the one or more content sources.

In addition, the signal library files can be enhanced through algorithms that use best-benchmarked data. In an embodiment, the signal library files are stored in the database 108 associated with the remote processing server 112. In another embodiment, the signal library files 222 are stored in a cloud database. In one embodiment, the signal library files may be received by the transceiver unit of the sense and pickup device depending upon factors such as need, accuracy, sophistication, and the like.

In one embodiment, the signal library files can go through algorithms of self-learning based on iterative minimization of error of actual output with respect to desired output through a feedback mechanism. The feedback mechanism may be machine-based and/or human-based. In one embodiment, the signal library files involves processing in analog and digital signal processing.

The signal library files can be generated using intelligent algorithms, including, but not limited to, Convolution, Fast Fourier Transform (FFT), Correlation, Adaptive filtering, Kalman filtering, Wavelet Transform, and Compression algorithms. The signal library files can also be used to perform various techniques, such as filtering, Fourier analysis, noise reduction, compression, modulation, demodulation, and the like.

In one embodiment, the low power supply unit 520 is configured to power the signal conditioning unit 516. More specifically, the low power supply unit 520 provides operating power to the signal conditioning unit 516. The signal conditioning unit 516 then provides the front-end signal to the signal transceiver unit 518.

In an embodiment, the signal transceiver unit 518 is configured to transmit the front-end signal to the remote processing server 508 via the network 510. In addition, the I/O unit 522 is configured to transmit the signal configuration information to the remote processing server 508 via the network 510. In one example, the signal configuration information is associated with the input signal. It is noted that the front-end signal is an enhanced and improved form of the input signal. In an embodiment, the at least one communication channel includes at least one of a wired communication channel or a wireless communication channel (e.g., the network 510).

Furthermore, the remote processing server 508 is configured to perform processing on the front-end signal to generate the output signal. The processing is performed based, at least in part, on the signal configuration information and signal library files. In one embodiment, the remote processing server 508 has access to the signal library files. In one example, the remote processing server 508 is configured to perform processing on the front-end signal based at least on the utilization of the signal library files.

More specifically, the remote processing server 508 is configured to perform processing on the raw data (i.e., the front-end signal) received from the sense and pick up device. The processing is performed based at least on the signal configuration information and the signal library files. The output signal is then converted into the desired format based at least on the signal configuration information and the signal library files. The I/O unit 522 further receives instructions from the remote processing server to display the output signal in desired format (e.g., waveform, digital and/or analog read-outs, etc.) on a display.

Additionally, the remote processing server can perform analysis on the front-end signal to extract useful information or make informed decisions. In various examples, the analysis may be performed to detect patterns or features in the front-end signal, to classify the front-end signal into various categories, to estimate values of certain parameters, and the like.

In an embodiment, the display may be embedded in the I/O unit 522 of the sense and pickup device. In another embodiment, the I/O unit 522 may further transmit the output signal to the remote I/O unit 514 associated with another sense and pickup device. The remote I/O unit 514 may then display the output signal on a display (e.g., remote display or embedded display with the sense and pickup device). In an embodiment, the I/O unit 514 is a remote unit existing outside of the sense and pickup device. In another embodiment, the I/O unit 522 is an internal unit integrated with the sense and pickup device.

The power supply server 512 is configured to provide operating power to the remote processing server 508. In this manner, a single processing server (i.e., the remote processing server 508) manages the input signals from the one or more content sources, and therefore, the processing of all the input signals is performed at the remote processing server 508 only. In this manner, the remote processing server 508 and the power supply server 512 are shared among the one or more content sources and thus save power and other resources, such as volatile and non-volatile memories.

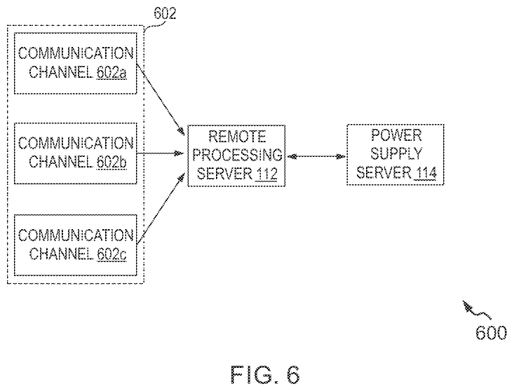

FIG. 6 illustrates a block diagram representation 600 of remotely sharing the remote processing server 112 over one or more communication channels, in accordance with an embodiment of the present invention.

The block diagram representation 600 includes a communication channel 602a, a communication channel 602b, and a communication channel 602c (collectively, referred to as communication channels 602), the remote processing server 112, and the power supply server 114.

In an embodiment, the communication channels 602 may refer to physical transmission mediums (such as wires) to transmit the front-end signal. In another embodiment, the communication channels 602 may refer to logical connections over multiplexed mediums (such as radio channels) to transmit the front-end signal.

The remote processing server 112 can manage all the communication channels 602. In an embodiment, the communication channels 602 can be located at different sites in the same facility (e.g., medical laboratory, electronic labs). In another embodiment, the communication channels 602 can be located at a single site in the same facility (e.g., medical laboratory). In yet another embodiment, the communication channels 602 can be located at different sites in different facilities (e.g., medical laboratory).

In an embodiment, each communication channel (e.g., the communication channel 602a) may receive the front-end signals from various sense and pickup devices (e.g., the sense and pickup device 106). In another embodiment, each communication channel (e.g., the communication channel 602b) may receive the front-end signals from only a single sense and pickup device 106. In an embodiment, the communication channels 602 communicates with the remote processing server 112 using a wired transmission medium (e.g., cable). In another embodiment, the communication channels 602 communicate with the remote processing server 112 using a wireless transmission medium (e.g., wireless-fidelity (Wi-Fi)).

In an embodiment, the communication channels 602 can communicate with the I/O unit 212 of the sense and pickup device 106 using a wired transmission medium (e.g., cable). In another embodiment, the communication channels 602 can communicate with the I/O unit 212 of the sense and pickup device 106 using a wireless transmission medium (e.g., Wi-Fi). In one example, the wired or wireless communication can be analog or digital in nature. In one embodiment, each communication channel (e.g., the communication channel 602a) of the communication channels 602 can have its own I/O unit (e.g., the I/O unit 212).

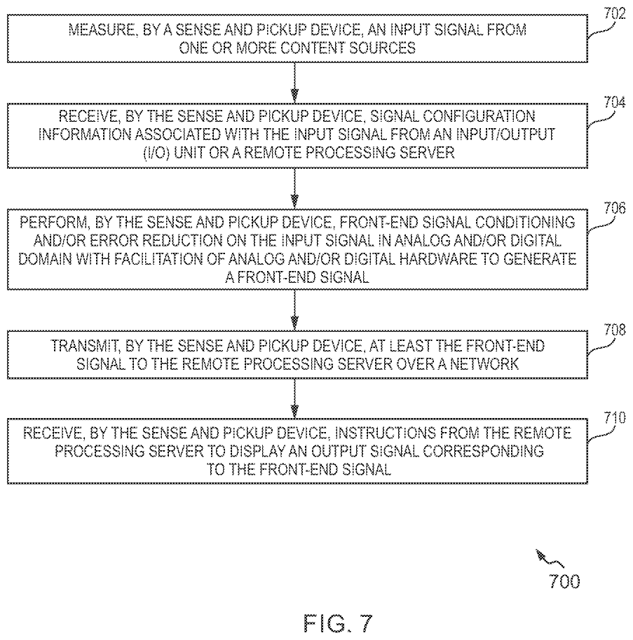

FIG. 7 illustrates a flow diagram of a method 700 for sharing the remote processing server 112 among the one or more content sources, in accordance with an embodiment of the present invention. The various steps and/or operations of the flow diagram, and combinations of steps/operations in the flow diagram, may be implemented by, for example, hardware, firmware, a processor, circuitry, and/or by the sense and pickup device 106 of FIG. 1A associated with the execution of software that includes one or more computer program instructions. It is noted that to explain the method 700; references can be made to components described in the subsequent FIGS. 1A to 6.

At 702, the method 700 includes measuring, by the sense and pickup device 106, the input signal from the one or more content sources. In one embodiment, the input signal is one of analog or digital.

At 704, the method 700 includes receiving, by the sense and pickup device 106, the signal configuration information associated with the input signal from the input/output (I/O) unit or the remote processing server. The signal configuration may include desired range of signal, accuracy, and the like. In an embodiment, the signal configuration information is received from the I/O unit 212. In another embodiment, the signal configuration information is received from the remote processing server.

At 706, the method 700 includes performing, by the sense and pickup device 106, front-end signal conditioning and/or error reduction on the input signal in analog and/or digital domain with facilitation of analog and/or digital hardware to generate a front-end signal. The front-end signal is an enhanced version of the input signal. The front-end signal conditioning and/or error reduction is performed prior to transmission of the front-end signal to the remote processing server 112. The front-end signal conditioning and/or error reduction is performed based, at least in part, on utilization of the signal library files and the signal configuration information.

In one embodiment, the signal library files can be used to build various models for performing signal quality enhancement and error reduction. The various models may include, but are not limited to, mathematical models. Such models can be built with or without user intervention. Such models can also be used for signal regeneration/reproduction.

In some examples, the mathematical models can be built using various mathematical formulas, equations, and algorithms, for time and frequency domains and using real or complex numbers. Examples of mathematical models may include models built using Fourier transform, Fast Fourier transform (FFT), Discrete Fourier Transform (DFT), Laplace transform, and the like. In one embodiment, the front-end signal conditioning is performed to enhance the quality of the input signal. In one embodiment, the error reduction is performed to remove errors from the input signal.

At 708, the method 700 includes transmitting, by the sense and pickup device 106, at least the front-end signal to the remote processing server 112 over the network. In one embodiment, the transceiver unit of the sense and pickup device transmits the front-end signal to the remote processing server. The remote processing server 112 receives the front-end signal from the sense and pickup device 106. The remote processing server 112 may then perform analysis on the front-end signal to generate the output signal corresponding to the input signal.

At 710, the method 700 includes receiving, by the sense and pickup device 106, instructions from the remote processing server to display the output signal corresponding to the front-end signal. The output signal is generated based at least on processing of the front-end signal by the remote processing server 112.

The disclosed method 700 or one or more operations of the method 700 may be implemented using software including computer-executable instructions stored on one or more computer-readable media (e.g., non-transitory computer-readable media, such as one or more optical media discs, volatile memory components (e.g., DRAM or SRAM), or non-volatile memory or storage components (e.g., hard drives or solid-state nonvolatile memory components, such as Flash memory components) and executed on a computer (e.g., any suitable computer, such as a laptop computer, net book, Web book, tablet computing device, smart phone, or other mobile computing device). Such software may be executed, for example, on a device (e.g., the sense and pickup device 106), a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

Various example embodiments offer, among other benefits, techniques for establishing system, device, and method for remotely sharing a processing server among one or more content sources. An input signal is measured from one or more content sources. A signal configuration information associated with the input signal is received from an input/output (I/O) unit or the remote processing server. In addition, front-end signal conditioning and/or error reduction is performed on the input signal in analog and/or digital domain with facilitation of analog and/or digital hardware to generate a front-end signal. Further, at least the front-end signal is transmitted to the remote processing server over a network. Furthermore, instructions to display an output signal corresponding to the front-end signal are received from the remote processing server via an input/output (I/O) unit. The I/O unit may then display the output signal in a desired format on a display.

Although the disclosure has been described with reference to specific exemplary embodiments, it is noted that various modifications and changes may be made to these embodiments without departing from the broad spirit and scope of the disclosure. For example, the various operations, blocks, etc., described herein may be enabled and operated using hardware circuitry (for example, complementary metal-oxide-semiconductor (CMOS) based logic circuitry), firmware, software, and/or any combination of analog and digital hardware, firmware, and/or software (for example, embodied in a machine-readable medium). For example, the systems and methods may be embodied using transistors, logic gates, and electrical circuits (for example, application-specific integrated circuit (ASIC) circuitry and/or in Digital Signal Processor (DSP) circuitry).

Particularly, the sense and pickup device 106 and its various components such as the signal transceiver unit 208 may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause the processor 204 or the computer to perform one or more operations. A computer-readable medium storing, embodying, or encoded with a computer program, or similar language may be embodied as a tangible data storage device storing one or more software programs that are configured to cause the processor 204 or computer to perform one or more operations. Such operations may be, for example, any of the steps or operations described herein. In some embodiments, the computer programs may be stored and provided to a computer using any type of non-transitory computer-readable media. Non-transitory computer-readable media include any type of tangible storage media. Examples of non-transitory computer-readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer-readable media. Examples of transitory computer-readable media include electric signals, optical signals, and electromagnetic waves. Transitory computer-readable media can provide the program to a computer via a wired communication line (e.g., electric wires, and optical fibers) or a wireless communication line.

Various embodiments of the invention, as discussed above, may be practiced with steps and/or operations in a different order, and/or with hardware elements in configurations, which are different than those which are disclosed. Therefore, although the invention has been described based upon these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A system comprising:
one or more content sources;
a sense and pickup device comprising:
a signal transceiver unit configured to receive signal configuration information associated with an input signal from an input/output (I/O) unit or a remote processing server, wherein the I/O unit is communicatively coupled to the signal transceiver unit and the remote processing server, wherein the input signal is selected from the one or more content sources based, at least in part, on a multiplexer;
a signal conditioning unit configured to perform front-end signal conditioning and/or error reduction on the input signal in analog and/or digital domain with facilitation of analog and/or digital hardware to generate a front-end signal; and
the signal transceiver unit configured to transmit at least the front-end signal to the remote processing server over a network;
the remote processing server configured to perform processing on the front-end signal to generate an output signal, wherein the processing is performed based, at least in part, on the signal configuration information and signal library files; and
the I/O unit configured to receive instructions from the remote processing server to display the output signal in a desired format on a display.

2. The system of claim 1, wherein the I/O unit is configured to transmit the signal configuration information to the remote processing server over the network.

3. The system of claim 1, wherein the signal transceiver unit is configured to receive the signal library files over the network.

4. The system of claim 1, wherein the one or more content sources comprises at least one of electrical test and measurement signals and physical test and measurement signals.

5. The system of claim 4, further comprising:
a converter configured to convert the physical test and measurement signals to the electrical test and measurement signals.

6. The system of claim 1, wherein the input signal is one of analog or digital.

7. The system of claim 1, wherein the I/O unit is a remote unit existing outside of the sense and pickup device.

8. The system of claim 1, wherein the I/O unit is an internal unit integrated with the sense and pickup device.

9. The system of claim 1, further comprising:
a power supply server configured to provide operating power to the remote processing server.

10. The system of claim 1, further comprising:
an artificial intelligence (AI) unit configured to generate the signal library files, wherein the AI unit is communicably coupled to the remote processing server.

11. The system of claim 1, wherein the signal library files are stored in a database communicably coupled to the remote processing server.

12. A method for sharing a remote processing server among one or more content sources, the method comprising:
measuring, by a sense and pickup device, an input signal from the one or more content sources;
receiving, by the sense and pickup device, signal configuration information associated with the input signal from an input/output (I/O) unit or the remote processing server;
performing, by the sense and pickup device, front-end signal conditioning and/or error reduction on the input signal in analog and/or digital domain with facilitation of analog and/or digital hardware to generate a front-end signal;
transmitting, by the sense and pickup device, at least the front-end signal to the remote processing server over a network; and
receiving, by the sense and pickup device, instructions from the remote processing server to display an output signal corresponding to the front-end signal, wherein the output signal generated based at least on processing of the front-end signal by the remote processing server.

13. The method of claim 12, wherein the I/O unit is communicably coupled to the sense and pickup device and the remote processing server.

14. The method of claim 12, wherein the front-end signal conditioning and/or error reduction is performed prior to transmission of the front-end signal to the remote processing server.

15. The method of claim 12, wherein the front-end signal conditioning and/or error reduction is performed based, at least in part, on utilization of signal library files in analog and/or digital signal domain with facilitation of analog and/or digital hardware.

16. The method of claim 12, wherein the network corresponds to at least one of a wired network or a wireless network.

17. A sense and pickup device, comprising:
a signal transceiver unit;
a signal conditioning unit;
a memory comprising executable instructions; and
a processor communicably coupled to the memory, the processor configured to execute the instructions to cause the sense and pickup device, at least in part, to:
receive an input signal from one or more content sources;
receive signal configuration information associated with the input signal from an input/output (I/O) unit or a remote processing server;
perform front-end signal conditioning and/or error reduction on the input signal in analog and/or digital domain with facilitation of analog and/or digital hardware to generate a front-end signal;
transmit at least the front-end signal to the remote processing server over a network; and
receive instructions from the remote processing server to display an output signal corresponding to the front-end signal, wherein the output signal is generated based at least on processing of the front-end signal by the remote processing server.

18. The sense and pickup device of claim 17, wherein the I/O unit is communicably coupled to the signal transceiver unit and the remote processing server.

19. The sense and pickup device of claim 17, wherein the I/O unit is an internal unit integrated with the sense and pickup device.

20. The sense and pickup device of claim 17, wherein the I/O unit is a remote unit existing outside of the sense and pickup device.
